(19) United States
(12) Patent Application Publication
(10) Pub. No.: US 2026/0179275 A1
(43) Pub. Date: Jun. 25, 2026

(54) INFORMATION PROCESSING DEVICE

(71) Applicant: TOYOTA JIDOSHA KABUSHIKI KAISHA, Toyota-shi (JP)

(72) Inventor: Satoshi MIYAKE, Toyota-shi (JP)

(73) Assignee: TOYOTA JIDOSHA KABUSHIKI KAISHA, Toyota-shi (JP)

(21) Appl. No.: 19/374,962

(22) Filed: Oct. 30, 2025

(30) Foreign Application Priority Data
Dec. 23, 2024 (JP) 2024-226686

(51) Int. Cl. G06T 11/20; G06T 11/60

(52) U.S. Cl. CPC G06T 11/26; G06T 11/60

(57) ABSTRACT

An information processing device includes: an acquisition unit configured to acquiring a graph structure input by a user; a generation unit configured to generate an image based on the graph structure; and an output unit configured to output the generated image. The graph structure may include, for example, type information of an object and positional information of the object. The graph structure may include, for example, information on the shape or color of the object.

### CROSS-REFERENCE TO RELATED APPLICATION

This application claims priority to Japanese Patent Application No. 2024-226686 filed on Dec. 23, 2024. The disclosure of the above-identified application, including the specification, drawings, and claims, is incorporated by reference herein in its entirety.

### BACKGROUND

### 1. Technical Field

This disclosure relates to the technical field of information processing devices.

### 2. Description of Related Art

As an example of this type of device, a system has been proposed in which a large language model (LLM) is used to generate query data based on documents, and pairs of the documents and the query data are used to train a retrieval model for a dialogue bot (see Japanese Unexamined Patent Application Publication No. 2023-076413 (JP 2023-076413 A)).

### SUMMARY

When an image is generated using a machine-learned generative model, an image that does not match the user's intention (for example, an image that slightly deviates from the user's instruction) may be generated. In order to avoid such a situation, it is desirable to, for example, give the generative model an instruction that enables it to accurately understand the user's intention. However, it is not easy for the user to input such an instruction on their own.

The present disclosure has been made in view of the above issues, and an object thereof is to provide an information processing device that can appropriately generate an image intended by a user.

An information processing device according to one aspect of the present disclosure includes: an acquisition unit configured to acquiring a graph structure input by a user; a generation unit configured to generate an image based on the graph structure; and an output unit configured to output the generated image.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a hardware configuration of an information processing device according to an embodiment;

FIG. 2 is a block diagram illustrating a functional configuration of the information processing device according to the embodiment; and

FIG. 3 is a flowchart illustrating the operation flow of the information processing device according to the embodiment.

### DETAILED DESCRIPTION OF EMBODIMENTS

An embodiment of an information processing device will be described below with reference to the drawings.

### Hardware Configuration

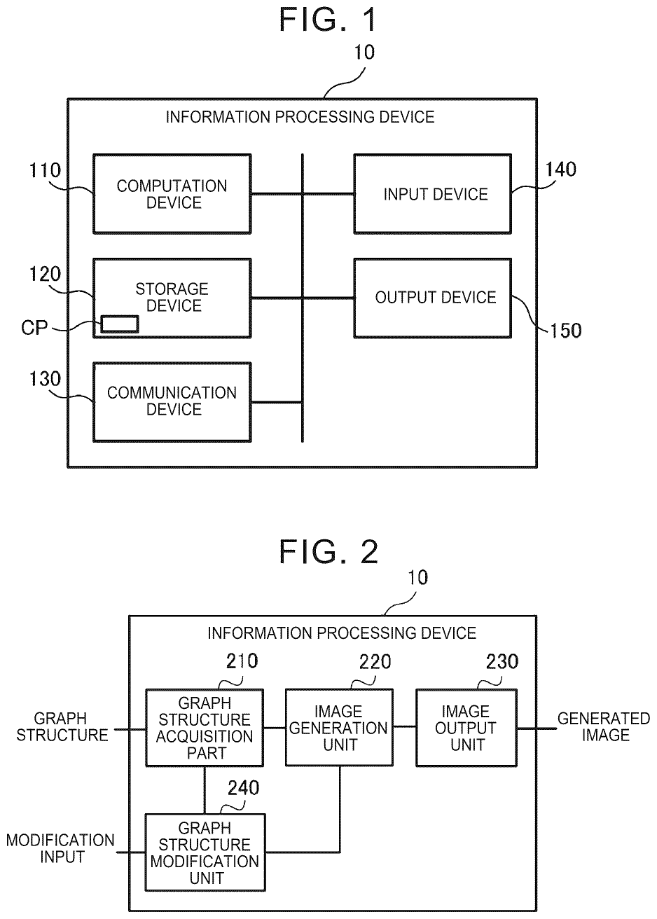

First, a hardware configuration of the information processing device according to the embodiment will be described with reference to FIG. 1. FIG. 1 is a block diagram illustrating the hardware configuration of the information processing device according to the embodiment.

In FIG. 1, an information processing device 10 according to the embodiment includes a computation device 110, a storage device 120, a communication device 130, an input device 140, and an output device 150. The computation device 110, the storage device 120, the communication device 130, the input device 140, and the output device 150 are connected to each other via a data bus.

The computation device 110 is configured to execute various computation processes in the information processing device 10. The computation device 110 may include a processor. The computation device 110 may include a single processor or may include a plurality of processors. In other words, the computation device 110 may include one or more processors. The processor may be a multicore processor. When the computation device 110 includes a single processor that is a multicore processor, the computation device 110 can logically be regarded as including a plurality of processors.

The processor included in the computation device 110 may be, for example, at least one of the following: a central processing unit (CPU), a graphics processing unit (GPU), a field programmable gate array (FPGA), and a tensor processing unit (TPU).

The storage device 120 may be, for example, at least one of the following: a random access memory (RAM), a read-only memory (ROM), a hard disk drive, a magneto-optical disk drive, a solid-state drive (SSD), and an optical disk array. That is, the storage device 120 may be implemented using a single device or may be implemented using a plurality of devices.

The storage device 120 is capable of storing desired data. The storage device 120 may store a computer program CP that is executed by the computation device 110. When the computation device 110 is executing the computer program CP, the storage device 120 may temporarily store data temporarily used by the computation device 110.

The computer program CP may be recorded on a computer-readable and non-transitory recording medium. In this case, the computer program CP may be stored in the storage device 120 by reading the recording medium using a recording medium reader (not shown) included in the information processing device 10. At least one of the following media may be used as the recording medium: an optical disk, a magnetic medium, a magneto-optical disk, a semiconductor memory, and any other medium capable of storing programs. The computer program CP may be acquired from a device (not shown) external to the information processing device 10 via the communication device 130. In other words, the computer program CP may be downloaded from an external device to the storage device 120 of the information processing device 10.

The computation device 110 (e.g., a processor), together with the storage device 120 storing the computer program CP (in other words, together with the storage device 120 and the computer program CP stored in the storage device 120), may execute processing to be performed by the information processing device 10. For example, logical functional blocks for executing the processing to be performed by the information processing device 10 may be implemented within the computation device 110 (e.g., within the processor) by the computation device 110 executing the computer program CP.

The communication device 130 is configured to communicate with a device external to the information processing device 10. The communication device 130 may perform wired communication or wireless communication.

The input device 140 is a device capable of receiving information input from outside to the information processing device 10. The input device 140 may include an operation device operable by a user of the information processing device 10 (e.g., a keyboard, a mouse, a touch panel, etc.). The input device 140 may include a recording medium reader capable of reading information recorded on a recording medium (such as a Universal Serial Bus (USB) memory) that is attachable to and detachable from the information processing device 10. When information is input to the information processing device 10 via the communication device 130 (in other words, when the information processing device 10 acquires information via the communication device 130), the communication device 130 may serve as an input device.

The output device 150 is a device capable of outputting information to the outside of the information processing device 10. The output device 150 may include a display device capable of outputting visual information such as text or images as the output information. The output device 150 may include a speaker capable of outputting auditory information such as sound as the output information. The output device 150 may be configured to output the above information (e.g., control information for other devices) to other devices. The output device 150 may be capable of outputting information to a recording medium that is attachable to and detachable from the information processing device 10, such as a USB memory. When the information processing device 10 outputs information via the communication device 130, the communication device 130 may serve as an output device.

### Functional Configuration

Next, a functional configuration of the information processing device 10 according to the embodiment will be described with reference to FIG. 2. FIG. 2 is a block diagram illustrating the functional configuration of the information processing device according to the embodiment.

In FIG. 2, the information processing device 10 is configured as a device that generates an image based on a graph structure input by a user. The information processing device 10 includes, as components for implementing its functions, a graph structure acquisition unit 210, an image generation unit 220, an image output unit 230, and a graph structure modification unit 240. Each of the graph structure acquisition unit 210, the image generation unit 220, the image output unit 230, and the graph structure modification unit 240 may be a processing block implemented by the computation device 110 described above.

The graph structure acquisition unit 210 is configured to acquire a graph structure input by a user. The graph structure may refer to data constituted by a group of nodes representing parts of an object contained in an image related to one piece of image data, and a group of edges indicating relationships between the nodes. The graph structure acquisition unit 210 may have a function to convert the acquired graph structure into a feature vector. The graph structure may include type information of an object and positional information of the object. Alternatively, the graph structure may include information on the shape or color of an object.

The image generation unit 220 is configured to generate an image from the graph structure acquired by the graph structure acquisition unit 210. That is, the image generation unit 220 converts a graph structure expressed by the user into an image. The image generation unit 220 may generate an image using a model that has been trained in advance by machine learning. The model may be a model that takes the graph structure (or the feature vector of the graph structure) as input and outputs an image.

The image output unit 230 is configured to output to the user an image generated by the image generation unit 220 (hereinafter referred to as “generated image” as appropriate). For example, the image output unit 230 may display on a display the image generated by the image generation unit 220. The image output unit 230 may display, in addition to the generated image, the graph structure used to generate the generated image (in other words, the graph structure input by the user).

The graph structure modification unit 240 is configured to modify the graph structure acquired by the graph structure acquisition unit 210 based on a modification input entered by the user. The modification input may include, for example, an instruction to modify part of the graph structure. For example, the user may select a portion to be modified in the graph structure and input, as the modification input, information for rewriting the selected portion. The graph structure modified by the graph structure modification unit 240 is output to the image generation unit 220. Therefore, when the graph structure modification unit 240 modifies the graph structure, the image generation unit 220 regenerates an image based on the modified graph structure.

### Operation Flow

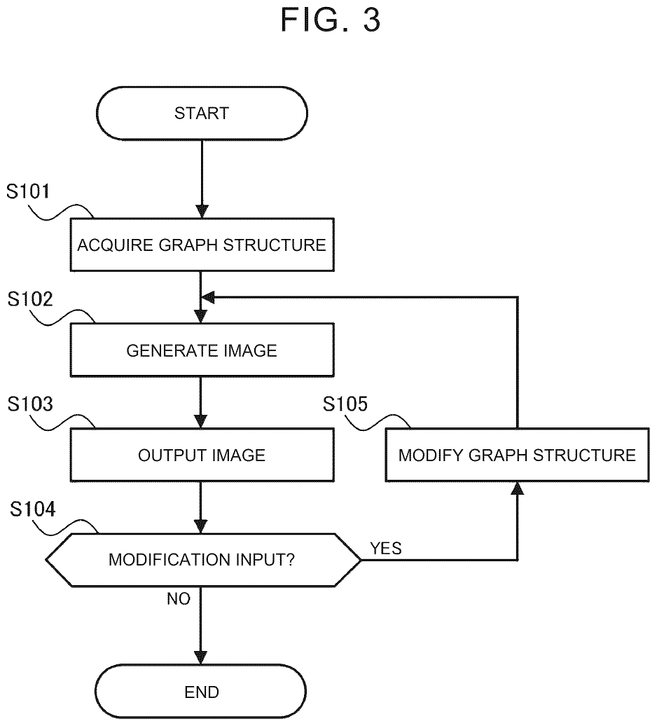

Next, the operation flow of the information processing device 10 according to the embodiment will be described with reference to FIG. 3. FIG. 3 is a flowchart illustrating the operation flow of the information processing device according to the embodiment.

As shown in FIG. 3, when the operation of the information processing device 10 according to the embodiment is started, the graph structure acquisition unit 210 first acquires a graph structure from a user (step S101). The image generation unit 220 then generates an image from the graph structure acquired by the graph structure acquisition unit 210 (step S102).

Thereafter, the image output unit 230 outputs the image generated by the image generation unit 220 (step S103). Subsequently, the graph structure modification unit 240 determines whether there has been any modification input from the user (step S104). When it is determined that there is no modification input (step S104: NO), the series of operations may end.

When there is a modification input (step S104: YES), the graph structure modification unit 240 modifies the graph structure based on the modification input (step S105). The process then returns to step S102, where the processing is performed using the modified graph structure. In this way, an image is generated and output based on the modified graph structure.

### Technical Effects

Next, technical effects obtained by the information processing device 10 according to the embodiment will be described.

As described with reference to FIGS. 1 to 3, in the information processing device 10 according to the embodiment, an image is generated from a graph structure input by a user. The graph structure is easy for a machine to interpret. Therefore, by using the graph structure to generate an image, it is possible to output an image that matches the user's intention.

In the case of a graph structure, it is easy to modify part of the information. For example, suppose the user inputs a graph structure “tree-leaf (color: green)-person-person,” and the image generation unit 220 generates an image of “a summer scene with people around a tree.” After this image is output, if the user modifies the information on the color of the leaves and the graph structure is changed to “tree-leaf (color: yellow)-person-person,” the image generation unit 220 generates an image of “an autumn scene with people around a tree.” In this way, by using a graph structure, an image that matches the user's intention can be generated by merely modifying part of the information.

Aspects of the disclosure derived from the above embodiment will be described below.

An information processing device according to one aspect of the present disclosure includes: an acquisition unit configured to acquiring a graph structure input by a user; a generation unit configured to generate an image based on the graph structure; and an output unit configured to output the generated image. In the above embodiment, the “graph structure acquisition unit 210” is an example of the “acquisition unit,” the “image generation unit 220” is an example of the “generation unit,” and the “image output unit 230” is an example of the “output unit.”

In the information processing device according to the above aspect, the graph structure may include type information of an object and positional information of the object. In this way, it becomes possible to more appropriately generate an image based on the type information and the positional information of the object included in the graph structure.

In the information processing device according to the above aspect, the graph structure may include information on the shape or color of the object. In this way, it becomes possible to more appropriately generate an image based on the information on the shape or color of the object included in the graph structure.

The information processing device according to the above aspect may further include a modification unit configured to modify, in response to an input of the user, part of the graph structure input by the user. The generation unit may be configured to, when the part of the graph structure has been modified, regenerate an image based on the graph structure resulting from modification. In this way, the generated image can be easily modified. In the above embodiment, the “graph structure modification unit 240” is an example of the “modification unit.”

The present disclosure is not limited to the embodiment described above, and various modifications can be made as appropriate without departing from the gist or spirit of the disclosure as understood from the claims and the entire specification. Information processing devices incorporating such modifications are also within the technical scope of the present disclosure.

What is claimed is:

1. An information processing device comprising:
an acquisition unit configured to acquiring a graph structure input by a user;
a generation unit configured to generate an image based on the graph structure; and
an output unit configured to output the generated image.

2. The information processing device according to claim 1, wherein the graph structure includes type information of an object and positional information of the object.

3. The information processing device according to claim 2, wherein the graph structure includes information on a shape or color of the object.

4. The information processing device according to claim 1, further comprising a modification unit configured to modify, in response to an input of the user, part of the graph structure input by the user,
wherein the generation unit is configured to, when the part of the graph structure has been modified, regenerate an image based on the graph structure resulting from modification.
